(19) United States
(12) Patent Application Publication
(10) Pub. No.: US 2025/0151744 A1
(43) Pub. Date: May 15, 2025

(54) SHELF-STABLE FERMENTED PLANT-BASED FOOD PRODUCT PACKAGED IN A FLEXIBLE CONTAINER AND PROCESS FOR PRODUCING SUCH PRODUCT

(71) Applicant: SOCIETE DES PRODUITS NESTLE S.A., Vevey (CH)

(72) Inventors: NOELIA MORAN HERNANDEZ, Bern (CH); GIULIA MARCHESINI, Maracon (CH); CHRISTOPH THOMAS WIDMER, Kehrsatz (CH); YUNITA LAKSMONO, Surabaya, East Java (ID); CRISTELA ARELI ZAYAS, Queretaro (MX); LORETO ALONSO, Bern (CH); JULIANA VALLE COSTA SILVA, Fribourg (CH)

(21) Appl. No.: 18/722,832

(22) PCT Filed: Dec. 21, 2022
(86) PCT No.: PCT/EP2022/087144

§ 371 Date: Jun. 21, 2024

(30) Foreign Application Priority Data
Dec. 22, 2021 (EP) 21216767.0

(51) Int. Cl. A23C 11/10; A23L 2/66; A23L 7/104; A23L 11/50; A23L 29/212; A23L 29/231; A23L 33/135

(52) U.S. Cl. CPC A23C 11/106; A23L 2/66; A23L 7/104; A23L 11/50; A23L 29/212; A23L 29/231; A23L 33/135

(57) ABSTRACT

The present invention relates to a process for preparing a packaged food product consisting of a shelf-stable plant-based fermented dairy analogue contained in a flexible container is disclosed. In particular, the shelf-stable plant-based fermented dairy analogue has a satisfactory and stable texture, including a texture suitable for consumption with a flexible container, such as flexible pouch. It also relates to resulting packaged food product consisting of a shelf-stable plant-based fermented dairy analogue contained in a flexible.

### TECHNICAL FIELD

The present invention relates generally to the field of plant-based fermented dairy analogues packaged in flexible containers. In particular, the present invention relates to a process for preparing a packaged food product consisting of a shelf-stable plant-based fermented dairy analogue contained in a flexible container. It also relates to packaged food product obtained by such a process.

### BACKGROUND OF THE INVENTION

Nowadays, more and more consumers are following alternative diets such as veganism, vegetarism, flexitarism and dairy-free diets. The vegan, vegetarian, flexitarian and dairy-free diets imply, to different extents, the consumption of food products of non-animal origin, including non-dairy food products. Food companies meet this new demand by offering food products of non-animal origin, including non-dairy food products. The amount of non-dairy food products on the market, including plant-based fermented dairy analogues, is continuously growing.

A major part of the plant-based fermented dairy analogues, e.g. plant-based yogurt analogues, on the market contain soy-based ingredients and/or have low amount of proteins. However, as their dairy counterparts, it is expected a substantial amount of proteins for plant-based fermented dairy analogues for nutritional considerations. In addition, soy-based ingredients are rejected by some consumers for transparency, health, nutritional and sustainability reasons.

In addition, the plant-based fermented dairy analogues on the market shall be stored under chilled conditions, that-is-to-say at a temperature of 1° C. to 10° C. and have a shelf-life of 30 days under chilled conditions. However, such chilled plant-based fermented dairy analogues may not be convenient for the consumers because they have a limited shelf-life of several days and cannot be safely taken away or stored in shelves without the need of a cold storage. They shall be stored under chilled condition (e.g. in a fridge) and shall be directly consumed after taking it out of the fridge to avoid any sanitary and hygienic risks.

The plant-based fermented dairy analogues are appreciated as snacks and they can be consumed on-the-go. As a reply to this consumption habit, plant-based fermented dairy analogues can be packaged in container adapted for on-the-go consumption. On-the-go packaging which are appreciated by consumers for their convenience are flexible containers, such as flexible pouches. In particular, the product is consumed by manually squeezing (i.e. pressing) the walls of the flexible container to discharge the product from the flexible container through its opening.

However, the texture (i.e. viscosity) of plant-based fermented dairy analogues should be mastered to ensure a proper consumption of the plant-based fermented dairy analogues with such a flexible container. The texture of plant-based fermented dairy analogue should not be too thick. This avoids waste by ensuring that part or the totality of the fermented dairy analogue is not blocked in the flexible container due to low flowing properties. In addition, this allows comfort by ensuring the fermented dairy analogue can be discharged out of the container through its opening by manually squeezing the walls without applying excessive effort. Alternatively, the texture of the plant-based fermented dairy analogue should not be too liquid. This avoids uncontrolled discharge of the fermented dairy analogue from the flexible container, even when applying a light manual pressure on the container's wall. This uncontrolled discharge of the fermented dairy analogue may cause waste and may cause the consumers dirty themselves or their surroundings. Moreover, it is expected that plant-based fermented dairy analogues which are contained into such flexible containers to have a satisfactory thickened texture as their dairy counterparts and so not too liquid texture.

The mastery of the texture of plant-based fermented dairy analogue to ensure a proper consumption with flexible containers is key but remains a challenge along the manufacturing process and with the use of plant-based ingredients.

In particular, the manufacture of shelf-stable plant-based fermented dairy analogues involve applying high-temperature treatment after fermentation, including during filling, to ensure a dairy analogue with extended shelf-life of several months. However, this high-temperature treatment negatively impacts the properties of the plant-based fermented dairy analogues. For example, it may involve generation of off-flavours, a loss of texture, the appearance of separation of phases, the appearance of an unpleasant grainy texture due to protein aggregation. In particular, the loss of texture may be quite high such that that shelf-stable plant-based fermented dairy analogues has an unsatisfactory liquid texture, which is not suitable for consumption with a flexible packaging.

In addition, the use of plant-based ingredients, such as cereal flour, which may be rich in fibers and other viscosity-increasing compounds, has tendency to provide an unsatisfactory thick texture which is not suitable for consumption with a flexible packaging, in particular upon successive heat-treatments along the process.

Hence, there is a need to provide a process for preparing a shelf-stable plant-based fermented dairy analogues, with a significant amount of proteins and with cereal flour, that have a shelf-life of several months under ambient conditions (i.e. from 20° C. to 35° C.) while having texture suitable for consumption with flexible container. Especially, there is a need that the shelf-stable plant-based fermented dairy analogues have homogeneous, stable, smooth and satisfactory texture over the process and over its shelf-life. Moreover, it is preferably desirable that the shelf-stable plant-based fermented dairy analogues have limited off-notes and good nutritional properties, such as good PDCAAS.

Any reference to prior art documents in this specification is not to be considered an admission that such prior art is widely known or forms part of the common general knowledge in the field.

### SUMMARY OF THE INVENTION

The object of the present invention is to improve the state of the art, and in particular to provide a process and packaged food products that overcome the problems of the prior art and addresses the needs described above, or at least to provide a useful alternative.

Accordingly, a first aspect of the invention proposes a process for preparing a packaged food product consisting of a shelf-stable plant-based fermented dairy analogue contained in a flexible container, wherein said process comprises the steps of:

(a) providing a plant-based food composition comprising plant protein-containing ingredient, cereal flour and hydrophilic liquid, wherein the plant-based food composition comprises 2.0 to 5.5 wt % plant proteins, wherein the plant protein-containing ingredient is different from the cereal flour,

(a) heating the plant-based food composition at 55° C. to 80°° C. for 5 to 15 minutes to obtain a gelatinized plant-based food composition,

(b) homogenizing the gelatinized plant-based food composition at a pressure above 50 bar,

(c) heat treating the gelatinized plant-based food composition at a temperature from 80° C. to 100° C. for 30 seconds to 10 minutes,

(d) inoculating the heat-treated and homogenized plant-based food composition with at least one starter culture to obtain an inoculated plant-based food composition,

(e) fermenting the inoculated plant-based food composition until reaching a pH of 3.0 to 5.0, preferably of 3.5 to 4.5, to obtain a plant-based fermented dairy analogue,

(f) heat-treating the plant-based fermented dairy analogue at a temperature from 75° C. to 125° C. for 3 seconds to 15 minutes to obtain a shelf-stable fermented dairy analogue,

(g) hot filling the shelf-stable fermented dairy analogue into a flexible container at a temperature of 80°° C. to 100° C. to obtain a packaged food product.

The process of the invention controls the texture of the resulting product to overcome the above-mentioned drawbacks. The process enables to provide a shelf-stable plant-based fermented dairy analogue which is packaged in a flexible container and which has a satisfactory and stable texture. In particular, the shelf-stable plant-based fermented dairy analogue has a texture which is suitable for consumption with a flexible container (i.e. not too thick, not too liquid). It may be discharged from the flexible container and so consumed/served easily through the opening of the flexible container without applying excessive efforts and without uncontrolled discharged.

A second aspect of the invention proposes a packaged food product which consists of a shelf-stable plant-based fermented dairy analogue contained in a flexible container, and wherein the shelf-stable plant-based fermented dairy analogue comprises:
hydrophilic liquid,
plant proteins, and said shelf-stable plant-based fermented dairy analogue has:
a pH of 3.0 to 5.0, preferably of 3.5 to 4.5,
from 2.0 wt % to 5.5 wt % of plant protein,
a shelf-life of at least 3 months at a temperature of 15° C. to 40° C., and
a viscosity of 300 to 1200 mPa.s at 100 s⁻¹ at 20° C. measured by means of a rheometer with plate-plate geometry (60 mm diameter) and with 1 mm gap.

The packaged food product of the invention is a shelf-stable plant-based fermented dairy analogue which is packaged in a flexible container and which has a satisfactory and stable texture. In particular, the shelf-stable plant-based fermented dairy analogue has a texture which is suitable for consumption with a flexible container (i.e. not too thick, not too liquid). It may be discharged from the flexible container and so consumed/served easily through the opening of the flexible container without applying excessive efforts and without uncontrolled discharged.

These and other aspects, features and advantages of the invention will become more apparent to those skilled in the art from the detailed description of embodiments of the invention, in connection with the attached drawings.

### DETAILED DESCRIPTION OF THE INVENTION

As used in the specification, the words “comprise”, “comprising” and the like are to be construed in an inclusive sense, that is to say, in the sense of “including, but not limited to”, as opposed to an exclusive or exhaustive sense.

As used in the specification, the singular forms “a”, “an”, and “the” include plural referents unless the context clearly dictates otherwise.

As used in the specification, the term “substantially free” means that no more than 10 weight percent, preferably no more than 5 weight percent, and more preferably no more than 1 weight percent of the excluded material is present. In a preferred embodiment, “substantially free” means that no more than 0.1 weight percent of the excluded material remains. “Entirely free” or “free” typically means that at most only trace amount of the excluded material is present, and preferably, no detectable amount is present.

Unless noted otherwise, all percentages in the specification refer to weight percent, where applicable.

Unless defined otherwise, all technical and scientific terms have and should be given the same meaning as commonly understood by one of ordinary skill in the art to which this invention belongs.

The term “shelf-stable” refers to a food product having a shelf-life of at least three months, preferably at least 6 months, more preferably at least 9 months, most preferably at least 12 months under ambient conditions, i.e. at a temperature of 15° C. to 40° C., preferably of 20° C. to 37° C., more preferably of 20° C. to 35° C. 30

In the present context, the term “shelf-life” refers to the period of time after production of a food product, during which the food product is transported and stored in retailers' or consumers' shelves before consumption.

The term “plant-based fermented dairy analogue” refers to a fermented edible food product which comprises ingredients of plant origin, which is free from dairy and which mimics the texture and the appearance of a fermented dairy product, such as yogurts. Preferably, such a fermented edible food product is also free from soy.

The term “plant-based fermented yogurt analogue” refers to a fermented edible food product which comprises ingredients of plant origin, which is free from dairy, and which mimics the texture and the appearance of a yogurt. Preferably, such a fermented edible food product is also free from soy.

The term “hydrophilic liquid” refers to an edible liquid which comprises at least 50% water, preferably at least 60% water, more preferably at least 70% water. In particular, the hydrophilic is not derived from milk and/or soy. For example, milk, dairy creams, soy cream or soy milk may be excluded from this definition.

The term “animal component” refers to any ingredients, semi-finished products or finished products derived from an animal. It includes dairy component. Examples of animal component include fish, meat, blood, milk, egg, squid ink and ingredients derived thereof.

The term “dairy component” refers to any ingredients, semi-finished products or finished products derived from a non-human mammal milk. Examples of dairy components include whole milk, semi-skimmed milk, skimmed milk, milk powder, condensed milk, buttermilk, butter, cream, whey proteins, caseins, yogurts, ice-creams and mixtures thereof.

The term “soy component” refers to any ingredients, semi-finished products or finished products derived from soy. Examples of soy components include soy proteins, soybean milk, soy lecithin, soy cream, soy milk, soy yogurt, whole soybeans and mixtures thereof.

The term “pulse” refers to edible dried seeds of plants in the legume family. Pulses generally grow in pods and vary in terms of size, color & shape. The four most common pulses are beans, chickpeas, lentils and peas. Examples of lentils, as Lens Culinaris, include Beluga Lentils, Brown Lentils, French Green Lentils, Green Lentils and Red Lentils. Examples of beans, as Phaseolus Vulgaris, include Adzuki Beans, Anasazi Beans, Appaloosa Beans, Baby Lima Beans, Black Calypso Beans, Black Turtle Beans, Dark Red Kidney Beans, Great Northern Beans, Jacob's Cattle Trout Beans, Faba Beans, Large Lima Beans, Mung Beans, Pink Beans, Pinto Beans, Romano Beans, Scarlet Runner Beans, Tongue of Fire, White Kidney Beans and White Navy Beans. Examples of peas include Black-Eyed Peas, Green Peas, Marrowfat Peas, Pigeon Peas, Yellow Peas and Yellow-Eyed Peas. Examples of chickpeas, as Cicer Arietinum, include Chickpea and Kabuli.

The term “non-inherent thickening agents” refers to agents that increase the viscosity of a food product. They may also be used to stabilize the food product, including by protecting the proteins and limiting their uncontrolled aggregation after a heat treatment. It includes gums, starches and the like. For avoidance of doubt, this definition excludes the plant protein-containing ingredient, the cereal flour, the hydrophilic liquid, the fermentable sugar-containing component and the vegetable fat component. It also excludes the inherent thickening agents that could be naturally present in the ingredients of the shelf-stable plant-based fermented dairy analogue.

The term “high methoxyl pectin” is a pectin having a degree of esterification (DE) of at least 50%, preferably from 55% to 80%, more preferably from 60% to 75%. The degree of esterification (DE) is defined as the number of methyl-esterified galacturonic acid units expressed as a percentage of the total galacturonic acid units in the pectin molecule.

In the present context, the terms “suitable/adapted for consumption with a flexible container” mean that the shelf-stable plant-based fermented dairy analogue has a texture, in particular flowing properties, which allows its consumption via a flexible container without inconvenience. In particular, the shelf-stable plant-based fermented dairy analogue does not have a too thick texture or a too liquid texture. Hence, the abovementioned drawbacks related to too thick or too liquid texture in the context of consumption with a flexible container are avoided.

In a first aspect, the invention relates to a process for preparing a packaged food product. The packaged food product consists of a shelf-stable plant-based fermented dairy analogue contained in a flexible container.

The flexible container has an opening and one or more wall(s) forming a hollow chamber. The opening may be closed by a lid and/or a cap. The hollow chamber is filled with the abovementioned shelf-stable plant-based fermented dairy analogue. The shelf-stable plant-based fermented dairy analogue within the hollow chamber is consumed or served through the opening. Preferably, the opening is located within a spout, preferably extending from the wall(s) of the flexible container and communicating with the hollow chamber. At least one wall of the flexible container is flexible. Preferably, all the walls of the flexible container are flexible. In particular, the flexible wall(s) is/are made of a material such that the wall(s) can be squeezed (i.e. pressed) with hands without damaging the wall(s). In particular, the application of pressure by squeezing on the flexible wall(s) with hands enable to discharge via the opening the shelf-stable plant-based fermented dairy analogue which is contained in the hollow chamber. For example, the flexible container may be made of a material comprising thermoplastic material, for example Polyethylene (PE), biaxially-oriented polyamide (BOPA), Polyethylene theraphtalate (PET), or a combination thereof. The material of the flexible container may comprise fiber-based material, in particular paper. The material of the flexible container may comprise aluminium. In a preferred embodiment, the flexible container is a flexible pouch, in particular spout pouch. More preferably, the flexible container is a single-serve flexible pouch, in particular single-serve spout pouch.

The flexible container comprises a shelf-stable plant-based fermented dairy analogue. In particular, the shelf-stable plant-based fermented dairy analogue is located within the hollow chamber of the flexible container.

The shelf-stable plant-based fermented dairy analogue is selected from the list consisting of shelf-stable plant-based fermented milk analogues, shelf-stable plant-based yogurt analogues, shelf-stable plant-based kefir dairy analogues and a combination thereof. Preferably, the shelf-stable plant-based fermented dairy analogue is a shelf-stable plant-based yogurt analogue.

Especially, the shelf-stable plant-based fermented dairy analogue is free from any dairy components. More generally, the shelf-stable plant-based fermented dairy analogue is preferably free from any animal components. In addition, the shelf-stable plant-based fermented dairy analogue is free from soy components. Indeed, soy & its derivatives (e.g. soy milk) are avoided by some consumers due to the potential presence in soy plant materials of molecules considered as endocrine disruptors (e.g. phytoestrogens, isoflavones) or even due to their potential GMO origin.

First, the process comprises a step (step (a)) of providing a plant-based food composition comprising plant protein-containing ingredient, cereal flour, hydrophilic liquid. In an embodiment, the plant-based food composition may further comprise fermentable sugar-containing component and/or vegetable fat component.

The food composition may comprise additional ingredients (e.g. vitamins, minerals, fibres . . . ) in addition to the ones previously cited, provided that these additional ingredients are not or do not comprise dairy components and/or soy components. Preferably, the additional ingredients are not or do not comprise animal components. It is also preferred that the plant-based food composition is prepared such that the plant protein-containing ingredient, the cereal flour, the optional fermentable sugar-containing component, the optional vegetable fat component and the potential additional ingredient are mixed at their targeted concentrations and such that the plant-based food composition is complemented with the hydrophilic liquid to reach 100 wt %.

The plant protein-containing ingredient is an ingredient which comprises a substantial amount of plant proteins, i.e., from 10 wt % to 98 wt % plant proteins. The plant protein-containing ingredient may be a plant protein concentrate, a plant protein isolate, a plant protein flour or a combination thereof. The term “plant protein flour” refers to a composition comprising a plant protein content from 10% to 49.9% proteins. The term “plant protein concentrate” refers to a composition comprising a plant protein content from 50% to 79.9%. The term “plant protein isolate” refers to a composition comprising a plant protein content from 80.0% to 98.0%. Preferably, the plant protein-containing ingredient is a plant protein concentrate, a plant protein isolate or a combination thereof. The plant protein concentrates and isolates are advantageous compared to plant protein flours. Indeed, flours are less pure than concentrates/isolates and may comprise a substantial of non-protein compounds, such as carbohydrates, fibers, etc, that may generate substantial increase in viscosity. Hence, excessive use of plant protein flour, in particular in combination with the cereal flour, may lead to a too thick texture which is not adapted to consumption with a flexible container. The plant protein-containing ingredient is free from soy components, dairy components and/or animal components.

In an embodiment, the proteins of the plant protein-containing ingredient comprise, preferably consist of, pulse proteins. Pulse proteins are preferred for the invention because they form a satisfactory gel upon acidification. They are not only able to provide a gel having a texture that mimics the texture of fermented dairy products, but they also participate in providing a gel having a texture suitable for consumption with a flexible container, i.e. not too liquid or not too thick. In a preferred embodiment, the proteins of the plant protein-containing ingredient comprise, preferably consist of, pulse proteins which are selected from the group consisting of bean proteins, chickpea proteins, faba bean proteins, lentil proteins, pea proteins, and a combination thereof. In a more preferred embodiment, the proteins of the plant protein-containing ingredient comprise, preferably consist of, pea proteins or faba bean proteins or combination thereof. Pea proteins and faba bean proteins are advantageous because they are able to provide satisfactory results in terms of gelation upon acidification. In particular, they contribute to achieve a range of textures that can mimic the texture of fermented dairy product, including textures that are suitable for consumption with a flexible container.

The cereal flour may be rice flour, oat flour, barley flour, wheat flour, rye flour, corn flour, maize flour or a combination thereof. The cereal flour comprises a substantial amount of carbohydrates, including starch. It comprises 50 wt % to 85 wt %, preferably 50 wt % to 75 wt % of carbohydrates. The carbohydrates of the cereal flour, in particular starch, are key. Indeed, they participate with the proteins in providing a shelf-stable plant-based fermented dairy analogue with a satisfactory texture. In particular, they increase the viscosity of the shelf-stable plant-based fermented dairy analogue and avoids the obtention after the process of a highly liquid texture which is unsuitable for consumption with a flexible container. In addition, the cereal flour may comprise a substantial amount of dietary fibers, preferably 5 wt % to 20 wt %, preferably 8 wt % to 15 wt % of dietary fibers. The dietary fibers may also contribute to increase the viscosity of the shelf-stable plant-based fermented dairy analogue. The cereal flour may also comprise 5 to 15 wt % of proteins. The cereal flour may be hydrolysed or non-hydrolysed flour or a combination of hydrolysed and non-hydrolysed flours, preferably a non-hydrolysed flour. Indeed, the use of non-hydrolyzed cereal flour is advantageous as it ensures the starches of the cereal flour are still native and so effectively increase the texture of the shelf-stable plant-based fermented dairy analogue. In a preferred embodiment, the cereal flour is hydrolysed oat flour, non-hydrolysed oat flour or a combination thereof, more preferably non-hydrolysed flour. The cereal flour is free from dairy components, soy components and/or animal components.

In an embodiment, the cereal flour may comprise 48 wt % to 85 wt %, preferably 50 wt % to 75 wt % of starch. In another embodiment, the cereal flour may comprise from 0 to 5 wt. % beta-glucans, preferably 2 to 5 wt. % beta-glucans.

In an embodiment, the plant-based food composition may comprise 1.0 to 25 wt % cereal flour, preferably 1.0 to 15 wt %. of cereal flour, more preferably 1.0 to 8 wt % cereal flour, even more preferably 1.0 to 7.0 wt cereal flour, even more preferably 1.0 to 6.0 wt % cereal flour, even more preferably 1.0 to 3 wt % cereal flour, most preferably 1.0 to 2.5 wt % cereal flour.

The plant protein-containing ingredient is different from the cereal flour. For example, if the cereal flour is an oat flour, the plant protein-containing ingredient is not an oat flour.

The hydrophilic liquid may be water or a plant-based liquid or a combination thereof. By “plant-based liquid”, it is understood a non-dairy liquid composition, which may be a viscous liquid composition such as a cream, which is derived from an edible plant source (e.g. fruits, grains, nuts, pulses, seeds and the like). The non-soy plant-based liquid may be a plant-based cream alternative, plant-based milk alternative, plant-based water and mixtures thereof. Examples of plant-based cream alternative include almond cream, cashew cream, coconut cream, hazelnut cream, peanut cream and mixtures thereof. Examples of plant-based milk alternative include almond milk, banana milk, cashew milk, chestnut milk, coconut milk, hazelnut milk, flaxseed milk, lupine milk, oat milk, peanut milk, pine nut milk, pistachio milk, rice milk, sesame seed milk, sunflower seed milk, walnut milk and mixtures thereof. Examples of plant-based water include coconut water. Preferably, the hydrophilic liquid is water and/or plant-based cream alternative. More preferably, the plant-based cream alternative is coconut cream. The hydrophilic liquid may contribute to improve the nutritional profile and/or the sensory profile of the shelf-stable yogurt analogue. Preferably, the hydrophilic liquid is free from soy components, dairy components and/or animal components.

The fermentable sugar-containing component is a component comprising 80 wt % to 100 wt % of sugars of non-dairy origin and which can be converted into organic acids (e.g. lactic acid, acetic acid, etc.) upon fermentation by starter cultures. Lactose is excluded from this definition. The cereal flour, the hydrophilic liquid and the plant protein-containing ingredient are also excluded from this definition. The acid formation will promote the formation of a gel with a sufficient consistency by the coagulation of plant proteins into a plant protein network. The consistency of the obtained gel can mimic the consistency of fermented dairy products, such as yogurts and is suitable for consumption with a flexible container. Especially, after fermentation, the final product may exhibit a texture with enhanced viscosity and mouthfeel. Examples of fermentable sugar-containing component include agave syrup, brown sugar, coconut sugar, corn syrup, dextrose, fructose, glucose, honey, invert sugar, maltose, molasse, sucrose and mixtures thereof. In a preferred embodiment, the fermentable sugar-containing component is sucrose. The fermentable sugar-containing component is optional as the other ingredients of the plant-based food composition may already comprise inherent fermentable sugar. For example, the cereal flour, the plant protein-containing ingredient or the hydrophilic liquid may comprise inherent fermentable sugar. Preferably, the fermentable sugar-containing component is free from soy components, dairy components and/or animal components. In an embodiment, the fermentable sugar-containing component is not optional.

In an embodiment, the plant-based food composition may comprise from 0 wt % to 15 wt % of fermentable sugar-containing component. More preferably, the plant-based food composition may comprise from 1 wt % to 15 wt % of fermentable sugar-containing component. More preferably, the plant-based food composition may comprise from 1 wt % to 10 wt % of fermentable sugar-containing component. Most preferably, the plant-based food composition may comprise from 2 wt % to 8 wt % of fermentable sugar-containing component. Such ranges guarantee a good sensory profile and/or an effective fermentation (i.e. low fermentation time to reach the targeted pH). In another embodiment, the plant-based food composition may comprise a total carbohydrates content of 1 to 20 wt % preferably, 5 to 18 wt %.

The vegetable fat component is an ingredient which comprises from 80 wt % to 100 wt % of vegetable fat i.e., non-dairy fat which is derived from plant. The vegetable fat component may be liquid, i.e. vegetable oil. The vegetable oil may be selected among the list consisting of almond oil, argan oil, avocado oil, canola oil, coconut oil, corn oil, cottonseed oil, grapeseed oil, hazelnut oil, hemp seed oil, macadamia nut oil, oat bran oil, olive oil, palm oil, peanut oil, pistachio oil, rapeseed oil, rice bran oil, soybean oil, sesame oil, sunflower seed oil, walnut oil and mixtures thereof. The vegetable fat component may be solid, i.e. vegetable butter and margarine. The vegetable butter may be selected among the list consisting of shea butter, cocoa butter and mixtures thereof. It may be a combination of vegetable oil, vegetable butter and/or margarine. The vegetable fat component is optional as the other ingredients of the plant-based food composition may already comprise inherent vegetable fat. For example, the cereal flour, the plant protein-containing ingredient or the hydrophilic liquid may comprise inherent vegetable fat. The vegetable fat provided by the vegetable fat component may contribute to improve the nutritional profile and/or the sensory profile, including the mouthfeel, of the shelf-stable plant-based fermented dairy analogue. Preferably, the vegetable fat component is free from soy components, dairy components and/or animal components. In an embodiment, the vegetable fat component is not optional.

In an embodiment, the plant-based food composition may comprise 0 wt % to 10 wt %, preferably 1 wt % to 10 wt %, more preferably 1 to 5 wt % of vegetable fat component. In a further embodiment, the plant-based food composition comprises a total fat content of 0 wt % to 15 wt %, preferably 1 wt % to 15 wt %, more preferably 1 wt % to 10 wt %, most preferably 1 to 5 wt % fat. In a preferred embodiment, the fat of the plant-based food composition consists of vegetable fat.

Said plant-based food composition comprises plant proteins. The plant proteins of the invention shall coagulate and shall form a gel upon acidification, especially upon fermentation. Indeed, the formation of a gel participated in increasing the viscosity of the final product and in the end, it can contribute to reach a range of textures that not only mimic the textures of fermented dairy products but also that are suitable for consumption with a flexible container. In particular, the plant-based food composition comprises 2.0 to 5.5 wt % plant proteins, preferably 2.0 wt % to 5.0 wt %, more preferably 2.0 wt % to 4.5 wt % or most preferably 2.5 wt % to 4.0 wt %. The term “plant proteins” refers to edible non-dairy proteins originated from plant materials. Preferably, soy proteins are excluded.

In an embodiment, the plant-based food composition comprises limited amount of plant proteins. In particular, the plant-based food composition comprises 2.0 to 3.5 wt %, more preferably 2.0 to 3.0 wt %, even more preferably 2.0 to 2.6 wt % plant proteins.

Without wishing to be bound by theory, these ranges of amount of plant proteins enables to reach a satisfactory texture upon acid gelation of plant proteins while minimizing protein precipitations upon heat treatment. Outside these ranges, the texture may be unsuitable for consumption with a flexible container (too liquid or too thick) and/or may be unpleasant with grainy sensation in mouth due to occurrence of protein aggregation. These ranges participate to achieve a plant-based fermented dairy analogue having a viscosity allowing its consumption with a flexible container and having a pleasant texture which is smooth in mouth (i.e. not grainy). In addition, these ranges of amount of plant protein, especially upper ranges, ensures an acceptable level of proteins for nutritional purposes.

In particular, the plant-based food composition may comprise 2.0 wt %, 2.1 wt %, 2.2 wt %, 2.3 wt %, 2.4 wt %, 2.5 wt %, 2.6 wt %, 2.7 wt %, 2.8 wt %, 2.9 wt %, 3.0 wt %, 3.1 wt %, 3.2 wt %, 3.3 wt %, 3.4 wt %, 3.5 wt %, 3.6 wt %, 3.7 wt %, 3.8 wt %, 3.9 wt %, 4.0 wt %, 4.1 wt %, 4.2 wt %, 4.3 wt %, 4.4 wt %, 4.5 wt %, 4.6 wt %, 4.7 wt %, 4.8 wt %, 4.9 wt %, 5.0 wt %, 5.1 wt %, 5.2 wt %, 5.3 wt %, 5.4 wt %, 5.5 wt % of plant proteins.

In a preferred embodiment the plant-based food composition has 70% to 98% of its total protein content which is originated from the plant protein-containing ingredient. In particular, the proteins of the plant-protein containing ingredient are the major proteins in the plant-based food composition while the proteins of the other ingredients, such as the cereal flour, are the minor proteins in the plant-based food composition. The different proteins contribute to provide a satisfactory texture by gelation upon acidification allowing consumption with a flexible container. However, the proteins of the plant-protein containing ingredient mainly contribute to the viscosity derived from protein gelation upon fermentation. In particular, the cereal flour mainly participates to the increase of the texture mainly through its carbohydrates, in particular its starches rather than its proteins. The use of a different source than the cereal flour for providing proteins limits the use of the cereal flour which is rich in carbohydrates and fibres. An excessive use of cereal flour may lead to a highly thick texture which is unpleasant and not suitable for consumption with a flexible container. Moreover, this may negatively impact the nutritional profile of the final product by increasing substantially the amount of carbohydrates. In a more preferred embodiment, the plant-based food composition has 70% to 98% of its total protein content which is pulse proteins. Details and advantages of pulse proteins are provided above.

In addition, the combination of cereal proteins with other proteins, in particular pulse proteins, may enable to achieve a good nutritional quality.

Indeed, plant-based proteins, including cereal proteins or pulse proteins alone, are often not as good in quality as dairy proteins. The protein digestibility-corrected amino acid score (PDCAAS) is a method of evaluating the quality of a protein based on both the amino acid requirements of humans and their ability to digest it. PDCAAS compares the amount of the essential amino acids in a food to a reference (scoring) pattern based on the essential amino acid requirements of a preschool-age child to determine its most limiting amino acid (amino acid score). This approach is recommended by the Food and Drug Administration (FDA) and is described in the 1991 FAO/WHO Protein Quality Report. The highest possible score is a 1.0 meaning, that after digestion, a protein having a PDCAAS of 1.0 provides (per unit of protein) 100% or more of the indispensable amino acids required.

The combination of cereal protein with other proteins, in particular pulse proteins enable to achieve a high PDCAAS. In particular, the plant-based food composition and the obtained shelf-stable plant-based fermented dairy analogue has a minimum PDCAAS of 0.80, preferably of 0.85-1.00, more preferably 0.90 to 1.00.

In another embodiment, the plant-based food composition may further comprise algae, antioxidants, cocoa, colours, fibres, flavours, flower essences, fruit preparations, minerals, salts, prebiotics, sauces, solid inclusions, spices, sweeteners, tea, vegetables and/or vitamins. The only condition is that these ingredients shall not be or shall not comprise a dairy component. Preferably, these ingredients shall not be or shall not comprise animal components and/or soy components.

After the preparation of the plant-based food composition, the process of the invention comprises a step of heating (step (b)) the plant-based food composition at 55° C. to 80° C. for 5 to 15 minutes to obtain a gelatinized plant-based food composition. Preferably, the heating step is performed at 55° C. to 75° C. In a preferred embodiment, this heat-treatment step is performed while stirring. This heat-treatment step allows gelatinization of the starch of the cereal flour. Without wishing to be bound by theory, this would avoid the plant-based food composition becomes too thick in terms of viscosity during the subsequent heat-treatment steps of the process, including during the hot filling. Hence, this would ensure that the final product has a texture suitable for consumption with a flexible container (i.e. not too thick). This would also ensure a good performance of the different heat treatments by allowing a good heat distribution. Finally, this would ensure a good process performance by avoiding fouling/blockage of the manufacturing lines. To put it in a nutshell, this step may allow to control the viscosity generated by the cereal flour along the process, in particular upon the different successive heat-treatment including hot filling.

After the obtaining of the gelatinized plant-based food composition, the process comprises a step (step (c)) of homogenizing the gelatinized plant-based food composition at a pressure above 50 bar and a step (step d) of heat treating the gelatinized plant-based food composition at a temperature from 80°° C. to 100° C. for 30 seconds to 10 minutes.

In a preferred embodiment, the homogenizing step may be performed at a pressure from 50 bar to 700 bar. Further preferably, the homogenizing step may be performed at a pressure from 50 bar to 500 bar. More preferably, the homogenizing step may be performed at a pressure from 50 to 300 bar. Most preferably, the homogenizing step may be performed at a pressure of 100 to 300 bar. Without wishing to be bound by theory, it is believed that the homogenizing step may contribute to functionalize the plant proteins. Indeed, the obtaining of a satisfactory texture resulting from the coagulation of plant proteins may be only possible after performing a homogenizing step. In the absence of homogenization step, the plant proteins may not provide, upon acidification, a satisfactory texture. Moreover, the homogenization step may contribute to limit the appearance of grainy texture in the final product. The homogenization step may be performed at a temperature from 50° C. to 80° C. More preferably, the homogenization step may be performed at a temperature from 60° C. to 75° C.

In another preferred embodiment, the heat-treating step of the gelatinized plant-based food composition may be performed at a temperature from 85° C. to 95°. In addition, the heat treatment may be performed for 30 seconds to 7 minutes, preferably for 30 seconds to 5 minutes. The heat treatment step is performed for hygiene and quality purposes. Indeed, this heat treatment prevents any development of unwanted micro-organisms in the plant-based fermented dairy analogue, such as bacteria or moulds that may affect negatively the organoleptic properties of the plant-based fermented dairy analogue, or that may be pathogenic. Moreover, without wishing to be bound by theory, it is believed that this heat treatment may contribute to the functionalization of the plant proteins but to a lesser extent than the homogenization step. For example, the heat-treatment may be carried out in an indirect manner by means of a heat-plate exchanger. As a variant, it is possible to carry it out in a jacketed holding unit or direct steam injection.

The heat-treatment step, in particular heat-treatment step (d) (i.e. heat treatment of the gelatinized plant-based food composition), may be upstream or downstream the homogenization step (step (c)). In a preferred embodiment, the homogenization step (step (c)) is upstream to the heat-treatment step (step (d)). Indeed, when the homogenization is downstream the heat-treatment step, the texture of the shelf-stable plant-based fermented dairy analogue is thinner (i.e. more liquid). Hence, when the homogenization is downstream the heat-treatment step, the texture of the final fermented dairy analogue may be unsatisfactory, including for consumption with a flexible container.

After the homogenization step and the heat-treatment step, it is obtained a heat-treated and homogenized plant-based food composition. In particular after these steps, the process of the invention comprises a step (step (e)) of inoculating the heat-treated and homogenized plant-based food composition with at least one starter culture to obtain an inoculated plant-based food composition. Especially, the starter culture is substantially free, preferably free from dairy components, animal components and/or soy components.

In a preferred embodiment, the at least one starter culture comprises at least one lactic acid-producing bacteria. Especially, the at least one lactic acid-producing bacteria is selected from the group consisting of Lactobacillus, Lacticaseibacillus, Lactiplantibacillus, Leuconostoc, Pediococcus, Lactococcus, Streptococcus, Bifidobacterium, Carnobacterium, Oenococcus, Sporolactobacillus, Tetragenococcus, Vagococcus, Weissella, and a combination thereof, preferably selected from the group consisting of Lactobacillus, Lacticaseibacillus, Lactiplantibacillus, Lactococcus, Streptococcus, Bifidobacterium and a combination thereof, further preferably selected from the group consisting of Lactobacillus, Lacticaseibacillus, Lactiplantibacillus, Streptococcus, Bifidobacterium and a combination thereof, most preferably selected from the group consisting of Streptococcus, Lactobacillus, and a combination thereof.

In a more specific embodiment, the lactic acid-producing bacteria is selected from the list consisting of Lactobacillus acidophilus, Lactobacillus delbrueckii subsp. bulgaricus, Lacticaseibacillus paracasei, Lacticaseibacillus casei, Lacticaseibacillus rhamnosus, Lactiplantibacillus plantarum, Lactobacillus johnsonii, Lactobacillus sporogenes (or bacillus coagulans), Streptococcus thermophilus, Lactococcus lactis subsp. lactis, Lactococcus lactis subsp. cremoris, strains from the genus Bifidobacterium and mixtures thereof.

In an embodiment, the starter culture may further comprise, in addition to the lactic acid-producing bacteria, at least one yeast and/or at least one acetic acid-producing bacteria. Preferably, the yeast is selected from the group consisting of Zygosaccharomyces, Candida, Kloeckera/Hanseniaspora, Torulaspora, Pichia, Brettanomyces/Dekkera, Saccharomyces, Lachancea, Saccharomycoides, Schizosaccharomyces Kluyveromyces and mixtures thereof. More preferably, the yeast is selected from the list consisting of Saccharomyces, Kluyveromyces and mixtures thereof. Preferably, the acetic acid-producing bacteria is selected from the group consisting of Acetobacter and Gluconacetobacter. These strains, in addition to lactic acid-producing strain, are for example used to produce dairy kefirs. Hence, by using these strains, the plant-based fermented dairy analogue of the invention can, for example, even more mimic dairy kefirs.

In a preferred embodiment, the non-dairy starter culture consists only of one or more lactic acid-producing bacteria. Preferably, the at least one non-dairy starter culture consists of one or more thermophilic lactic acid-producing bacteria strains. The term “thermophilic lactic acid-producing bacteria strains” refers to lactic acid-producing bacteria strains having an optimal growth at a temperature between 35° C. and 45° C. More preferably, the starter culture is selected among the list consisting of Lactobacillus delbrueckii subsp. bulgaricus, Lacticaseibacillus paracasei, Lactobacillus acidophilus, Streptococcus thermophilus, Bifidobacterium species and a combination thereof. Most preferably, the starter consists of a combination of Lactobacillus delbrueckii subsp. bulgaricus and Streptococcus thermophilus. Especially, Lactobacillus delbrueckii subsp. bulgaricus and Streptococcus thermophilus are the two staple strains that are used in dairy yogurts. Hence, by using these strains, the plant-based fermented dairy product analogues of the invention can even more mimic dairy yogurts.

After the inoculation step, the process of the invention comprises a step (step (f)) of fermenting the inoculated plant-based food composition until reaching a pH of 3.0 to 5.0, preferably of 3.5 to 4.5, to obtain a plant-based fermented dairy analogue. During the fermentation step, the starter culture converts the fermentable sugar into organic acids. The formation of organic acids, such as lactic acid, acetic acid, promotes the formation of a gel by the coagulation of plant proteins into a plant protein network. The fermentation contributes to provide a texture mimicking the texture of fermented dairy products, such as yogurts. Moreover, it also participates to provide a texture, including flowing properties, suitable for consumption with a flexible container. Moreover, without wishing to be bound by theory, it is believed that fermentation decreases off-notes brought by plant-based materials, such as plant proteins.

In a further embodiment, the fermentation step is performed at the temperature of optimal growth of the starter culture. The temperature of optimal growth of the starter culture may be easily determined by the person skilled in the art. Preferably, the fermentation step is performed at temperature from 15° C. and 45° C. More preferably, the fermentation step is performed at a temperature from 20°° C. to 45° C. or from 25°° C. to 45° C. Most preferably, the fermentation step is performed from 36° C. to 45° C. When the starter culture comprises yeast, the fermentation step may be performed between 15° C. and 30° C., preferably between 20° C. and 25° C.

In a preferred embodiment, the fermentation step is performed without stirring. Fermentation step with stirring tends to provide a fermented dairy analogue with lower viscosity than fermentation without stirring. Hence, the removal of stirring during fermentation ensures to maximize the texture of the obtained fermented dairy analogue before the subsequent heat-treatment that may lead to a substantial loss of viscosity. This may contribute to provide a final shelf-stable plant-based dairy product analogue that has a satisfactory texture, including a texture adapted to consumption with a flexible container.

In an embodiment, the process of the invention may comprise a step of adding at least one non-inherent thickening agent into the plant-based fermented dairy analogue.

The addition of non-inherent thickening agent(s) may allow to achieve a final product with a satisfactory texture, including a texture allowing its consumption with a flexible container. In particular, the non-inherent thickening agents may contribute to avoid separation of phase phenomenon and to protect the protein from uncontrolled aggregation upon heat treatment which may lead to unsatisfactory grainy texture in mouth. The non-inherent thickening agents may also contribute to increase the viscosity of the fermented dairy analogue to compensate the loss of texture that may occur during the heat treatments subsequent to the fermentation step. Examples of non-inherent thickening agents include acacia gum, agar, alginate, carrageenan, cellulose, carboxymethylcellulose, gellan, pectin, locust bean gum, xanthan gum, starch, and mixtures thereof.

If any non-inherent thickening agent is added, the addition step should occur after the homogenization step to maximize the viscosity of the fermented dairy analogue. This is in particular key when the thickening agent comprises or is pectin.

In particular, the non-inherent thickening agent may comprise or may be pectin and/or starch. Pectin contributes to protect the protein from uncontrolled aggregation upon heat treatment which may lead to unsatisfactory grainy textures. Starch contributes to increase the viscosity of the fermented dairy analogue to compensate the loss of texture that may occur during the subsequent heat treatments.

Preferably, the pectin is a high methoxyl pectin, more preferably citrus high methoxyl pectin. Also, preferably, the starch is modified starch. By “modified starch”, it is understood a starch which has been modified by physical, chemical or enzymatic treatment. More preferably, the starch is physically modified starch as it is perceived as natural.

Advantageously, the pectin is added such that the plant-based fermented dairy analogue, and so the shelf-stable plant-based fermented dairy analogue comprises 0.05 wt % to 2.0 wt % of pectin, preferably 0.2 to 1.0 wt % pectin. Also advantageously, the starch is added such that the plant-based fermented dairy analogue, and so the shelf-stable plant-based fermented dairy analogue comprises 0.1 wt % to 3.0 wt % of starch, preferably 1 wt % to 2 wt % starch.

In a preferred embodiment, the non-inherent thickening agent may comprise pectin and starch or may be a mixture of pectin and starch. The combination of both pectin and starch is advantageous as it combines the properties of both thickening agents. In particular, this limits loss of viscosity upon heat treatment and avoids the appearance of destabilization phenomenon that may render the texture of the final product unsuitable for consumption with a flexible container. In a more preferred embodiment, the starch and pectin are added separately. In particular, the addition of pectin is upstream the addition of starch.

In a particular embodiment, the pectin is a pectin solution. Especially, the pectin, preferably high methoxyl pectin, more preferably citrus high methoxyl pectin is hydrated into warm water to prepare a pectin solution. This step is prior its addition into the plant-based fermented dairy analogue. By “warm water”, it is understood a water having a temperature between 70°° C. and 80° C., preferably between 70° C. and 75° C. The temperature of the pectin solution should remain between 70° C. and 80° C., preferably between 70° C. and 75° C. before its addition into the plant-based fermented dairy analogue. The concentration of pectin, preferably high methoxyl pectin, more preferably citrus high methoxyl pectin within the pectin solution may be determined by the persons killed in the art depending on the application, the pectin characteristics and the equipment.

In an embodiment, the process does not comprise a step of addition of any non-inherent thickening agents. Preferably, the process does not comprise a step of addition of any non-inherent thickening agents other than pectin and/or starch. Examples of non-inherent thickening agents other than pectin and/or starch include acacia gum, agar, alginate, carrageenan, gellan, locust bean gum, xanthan gum, and mixtures thereof. In particular, the shelf-stable plant-based fermented dairy analogue is substantially free, preferably entirely free from any non-inherent thickening agents, preferably from any non-inherent thickening agents other than pectin and/or starch. Despite the heat treatment and hot filling after the fermentation, the shelf-stable plant-based fermented analogue may have satisfactory smooth and thick texture and no protein aggregation or any other destabilisation phenomena may be observed when no non-inherent thickening agents are used or when pectin and/or starch are used without any other non-inherent thickening agents.

In particular, the process of the invention may comprise a smoothing step. The smoothing step is after the fermentation step (f) and the heat treatment step (g). In particular, the smoothing step may be after and/or before the addition of the thickening agent, if any. In particular, when pectin and starch are added separately, the smoothing step is after the addition of pectin but before the addition of starch.

The smoothing step may be performed with a rotor stator smoothing device as described in EP1986501 A1. Moreover, the smoothing step may be performed with a smoothing device, such as a smoothing device providing by Ytron, at a rotation speed of from 20 Hz to 60 Hz, preferably from 20 Hz to 40 Hz, most preferably from 25 Hz to 35 Hz. The smoothing step enables to smooth and homogenize the gel obtained after fermentation into a homogenous fermented dairy analogue having no or limited grainy texture. Especially, the smoothing device shall minimize the loss of viscosity that may occur after the smoothing step. Hence, a plant-based fermented dairy analogue with a satisfactory texture, especially viscosity and mouthfeel, is obtained. Moreover, the smoothing step enables to ensure a good incorporation of pectin and maximize its thickening and protective properties.

The process of the invention comprises a heat treatment after the fermentation step. Especially, the process comprises a step (step (g)) of heat-treating the plant-based fermented dairy analogue at a temperature from 75°° C. to 125° C. for 3 seconds to 15 minutes to obtain a shelf-stable fermented dairy analogue. Preferably, the heat treatment is performed at a temperature from 90° C. to 125° C. for 3 seconds to 90 seconds.

This heat treatment enables to considerably extend the shelf-life of the shelf-stable plant-based fermented dairy analogue, especially the shelf-life of the shelf-stable plant-based fermented dairy analogue is of at least 3 months, preferably at least 6 months, more preferably at least 9 months, most preferably at least 12 months under ambient conditions without involving sanitary risks. In a more preferred embodiment the plant-based fermented dairy analogue may have a shelf-life of 3 months to 36 months, preferably of 3 months to 24 months, more preferably of 3 months to 12 months, most preferably of 3 months to 6 months under ambient conditions. By “ambient conditions”, it is understood at a temperature of 15° C. to 40° C., preferably of 20° C. to 37° C., more preferably of 20° C. to 35° C. The obtained shelf-stable plant-based fermented dairy analogue is more convenient for the consumer than a chilled plant-based fermented dairy analogue. Indeed, the shelf-stable plant-based fermented dairy analogue may be safely taken away or stored in shelves without the need of a cold storage at a temperature between 1° C. and 10° C. In an embodiment, the abovementioned shelf-life values apply at a relative humidity of 60% to 75%. The relative humidity may be measured with a hygrometer, for example a psychometrer or a wet-and-dry-bulb thermometer.

The process of the invention further comprises a step (step (h)) of hot filling the shelf-stable fermented dairy analogue into a flexible container at a temperature of 80° C. to 100° C. to obtain a packaged food product . Preferably, the hot filling step is performed at a temperature of 85° C. to 95° C. Flexible containers cannot be generally sterilized. Hence, hot-filling enables to ensure the sterility of the shelf-stable fermented dairy analogue into the flexible container and to ensure that the packaged food product maintain an extended shelf-life. In particular, the packaged food product, including the shelf-stable plant-based fermented dairy analogue it contains, have the same shelf-life as mentioned above for the shelf-stable plant-based fermented dairy analogue.

The protein network formed after fermentation is very sensitive, especially sensitive to heat treatments. Applying heat treatment step and hot filling step after fermentation may lead to an undesirable aggregation of the proteins, to a separation of phases, and leads to a significant loss of texture. The loss of texture may lead to an unsatisfactory texture, especially, a texture which is not adapted for consumption with a flexible container. The separation of phases leads to an unattractive heterogeneous aspect and to an unpleasant sensory experience. The aggregation of proteins generates an unpleasant grainy texture in mouth and in certain case, to an unattractive aspect by the appearance of grains into the fermented dairy analogues.

To avoid the foregoing, it has been discovered that the different step of the process of the invention maximizes the texture of the fermented dairy analogue to compensate the substantial texture loss that will occur during the heat treatment and the hot filling steps after the fermentation step. Hence, the process enables to provide a fermented dairy analogue that maintains a texture which is adapted for consumption with a flexible container despite the high temperature treatments after fermentation.

Despite the process of the invention maximizes the texture of the fermented dairy analogue, this is performed in a controlled manner. In particular, the process does not generate too thick texture that would make the fermented dairy analogue not adapted anymore for consumption with a flexible container. It does not generate too thick texture despite the presence of cereal flour and several successive heat-treatment (incl. hot filling).

Preferably, the process may provide a shelf-stable plant-based fermented dairy analogue with a good taste, in particular with limited off-notes.

In addition, it has been discovered that the process, including the use of non-inherent thickening agent if any, before the heat treatment enables to protect the proteins from the heat treatment after fermentation and improve the stability of the shelf-stable plant-based fermented dairy analogue. Especially, the shelf-stable plant-based fermented dairy analogue has a smooth and homogeneous texture, does not exhibit separation of phases and does not exhibit grainy texture.

In an embodiment, the process does not comprise any step consisting of ultrasound processing, pulsed light treatment and/or ultra high pressure homogenization (UHPH). Ultra high pressure homogenization corresponds to an homogenization step which is performed at a pressure of at least 50 MPa, preferably at a pressure of 50 MPa to 500 MPa, more preferably at a pressure of 200 MPa to 400 MPa. Ultrasound processing, pulsed light treatment and ultra high pressure homogenization are mild technologies, in particular low temperature technologies, that enable to extend the shelf-life of a food while limiting stability issues (e.g. separation of phase such as creaming, sedimentation, protein aggregation etc. . . . ) related to high temperature heat-treatment, such as sterilization. It has been discovered that the process of the invention enables to provide shelf-stable plant-based fermented dairy analogues having an extended shelf-life and having good stability (e.g. limited separation of phase, limited protein aggregation etc. . . . ) without using any of the precited mild technologies, which may be expensive and hard to implement at an industrial scale. In particular, such a fermented dairy analogue with extended shelf-life and good stability may be achieved even by using high temperature processing steps after the fermentation step.

In an embodiment, the process does not comprise a step of addition of any enzymes, in particular any hydrolysing enzymes and/or any protein crosslinking enzymes. In particular, the process does not comprise a step of addition of starch-degrading and/or beta-glucan-degrading enzymes and/or fiber-degrading enzymes and/or protein-degrading enzymes and/or protein crosslinking enzymes. Examples of starch-degrading enzyme include alpha-amylase, beta-amylase, amyloglucosidase or a mixture thereof. Examples of beta-glucan-degrading enzymes include beta-glucanase, laminarinase or a mixture thereof. Examples of protein-degrading enzymes include protease, proteinase, peptidase, deamidase or a mixture thereof. Examples of protein crosslinking enzymes include transglutaminase. Examples of fiber-degrading enzymes include pullulanase, pectinase, mannanase or a mixture thereof. The process of the invention allows the mastery of the viscosity and the stability of the fermented dairy analogue along the process without using enzymes. The fermented dairy analogue has a satisfactory and stable texture without using enzymes.

In a further embodiment, the process may comprise a step of mixing the plant-based fermented dairy analogue with a fruit preparation, preferably a fruit puree. Examples of fruit puree include banana puree, strawberry puree, raspberry puree, apple puree, apricot puree, blueberry puree, peach puree, cherry puree, mango puree, passionfruit puree, blackberry puree, pineapple puree, plum puree, pear puree, kiwi puree, lychee puree and a combination thereof. This mixing step is prior step (g) (i.e. prior the heat treatment) and is subsequent to step (f) (i.e. subsequent to the fermentation step), preferably subsequent to the smoothing step, if any.

In a more preferred embodiment, the fruit preparation is mixed with the plant-based fermented dairy analogue such that the plant-based fermented dairy analogue comprises 5-50 wt % fruit preparation, preferably 7-40 wt % fruit preparation, more preferably 7-30 wt %, most preferably 15-26 wt %.

The process may further comprise a step of mixing the shelf-stable plant-based fermented dairy analogue with additional ingredients such as algae, antioxidants, cocoa, colours, fibres, flavours, flower essences, fruits, fruit preparations, minerals, salts, prebiotics, sauces, solid inclusions, spices, tea, sweeteners, vegetables and/or vitamins.

The shelf-stable plant-based fermented dairy analogue of the packaged product has a texture (i.e. viscosity) that enables its consumption with a flexible container. In particular, the product is neither too thick nor too liquid such that the abovementioned drawbacks related to such textures are avoided. In particular, the shelf-stable plant-based fermented dairy analogue of the invention may be discharged from the flexible container and so consumed/served easily without applying excessive efforts and without uncontrolled discharged. In particular, the shelf-stable plant-based fermented dairy analogue has flowing properties such that it is not blocked within the flexible container. In addition, it has a texture (i.e. viscosity) that can mimic the texture of fermented dairy products, such as yogurts.

Especially, in an embodiment, the shelf-stable plant-based fermented dairy analogue has a viscosity of 300 to 1200 mPa.s, preferably of 350 to 1100 mPa.s, more preferably of 350 to 850 mPa.s, most preferably 350 to 500mPa.s at 100 s⁻¹ at 20° C. when measured by means of a rheometer with plate-plate geometry (60 mm diameter) and with 1 mm gap.

For example, the viscosity of the shelf-stable plant-based fermented dairy analogue may be measured at 7 days after the preparation of the packaged food product. First, the packaged food product is stored at a temperature of 20° C. for a minimum of 2 hours prior to measurement. Then, a sample of the shelf-stable plant-based fermented dairy analogue is discharged from the flexible container and is gently stirred in a circular motion 3 times before transferring to Rheometer Haake RS600 (ThermoFisher Scientific, Waltham, Massachusetts, United-States) with plate/plate geometry (60 mm diameter), especially plate/plate geometry PP60, and with 1 mm gap. Flow curves with controlled shear rate ramp from 0 to 300 s⁻¹ (linear increase) may be obtained at 10° C.+/−0.1. Especially, the viscosity is measured using Rheowin software (ThermoFisher Scientific, Waltham, Massachusetts, United-States) in terms of Pa*s at 100s⁻¹ at 20° C.

In an embodiment, the shelf-stable plant-based fermented dairy analogue may comprise 0.5 to 5 wt. %, preferably 0.6 to 4 wt. %, more preferably 1 to 4 wt. %, most preferably 1 to 3 wt % starch. The shelf-stable plant-based fermented dairy analogue may comprise 0 to 1 wt. %, preferably 0.05 to 1 wt. % starch, more preferably 0.05 to 0.5 wt. % beta-glucan. These contents may contribute to provide an appropriate texture which is suitable/adapted for consumption with a flexible container. In an embodiment, the features related to the plant-based food composition may also apply to the shelf-stable plant-based fermented dairy analogue of the packaged food product.

In a second aspect, the invention relates to a packaged food product which consists of a shelf-stable plant-based fermented dairy analogue contained in a flexible container.

The flexible container of the packaged food product may be a flexible container as provided in the first aspect of the invention.

The features of the shelf-stable plant-based fermented dairy analogue of the packaged food product provided in the first aspect of the invention apply to the shelf-stable plant-based fermented dairy analogue of the packaged food product according to the second aspect of the invention, and vice versa. In a preferred embodiment, the packaged food product is obtained by the process according to the first aspect of the invention.

The shelf-stable plant-based fermented dairy analogue comprises a hydrophilic liquid. The hydrophilic liquid may be a hydrophilic liquid as provided in the first aspect of the invention.

The shelf-stable plant-based fermented dairy analogue comprises plant proteins. Indeed, the shelf-stable plant-based fermented dairy analogue may comprise at least one cereal flour and at least one plant protein-containing ingredient. The cereal flour and the plant protein-containing ingredient may be a cereal flour and a plant protein-containing ingredient as provided in the first aspect of the invention. The advantage of the plant proteins, the cereal flour and the plant protein-containing ingredient are provided in the first aspect of the invention.

In an embodiment, the shelf-stable plant-based fermented dairy analogue may comprise 1.0 to 25 wt % cereal flour, preferably 1.0 to 15 wt %. of cereal flour, more preferably 1.0 to 8 wt % cereal flour, even more preferably 1.0 to 7.0 wt cereal flour, even more preferably 1.0 to 6.0 wt % cereal flour, even more preferably 1.0 to 3 wt % cereal flour, most preferably 1.0 to 2.5 wt % cereal flour. The shelf-stable plant-based fermented dairy analogue has a substantial amount of plant proteins. In particular, it may have from 2.0 to 5.5 wt % plant proteins, preferably 2.0 wt % to 5.0 wt %, more preferably 2.0 wt % to 4.5 wt %, most preferably 2.5 wt % to 4.0 wt % plant proteins. The advantages of these plant protein ranges are provided in the first aspect of the invention.

In an embodiment, the shelf-stable plant-based fermented dairy analogue comprises limited amount of plant proteins. In particular, the shelf-stable plant-based fermented dairy analogue comprises 2.0 to 3.5 wt %, more preferably 2.0 to 3.0 wt %, even more preferably 2.0 to 2.6 wt % plant proteins.

In a particular embodiment, the shelf-stable plant-based fermented dairy analogue may have 2.0 wt %, 2.1 wt %, 2.2 wt %, 2.3 wt %, 2.4 wt %, 2.5 wt %, 2.6 wt %, 2.7 wt %, 2.8 wt %, 2.9 wt %, 3.0 wt %, 3.1 wt %, 3.2 wt %, 3.3 wt %, 3.4 wt %, 3.5 wt %, 3.6 wt %, 3.7 wt %, 3.8 wt %, 3.9 wt %, 4.0 wt %, 4.1 wt %, 4.2 wt %, 4.3 wt %, 4.4 wt %, 4.5 wt %, 4.6 wt %, 4.7 wt %, 4.8 wt %, 4.9 wt %, 5.0 wt %, 5.1 wt %, 5.2 wt %, 5.3 wt %, 5.4 wt %, 5.5 wt % of plant proteins.

In a preferred embodiment, the plant protein content of the shelf-stable plant-based fermented dairy analogue is equal to the total protein content of the shelf-stable plant-based fermented dairy analogue.

The plant proteins may comprise or consist of cereal proteins, preferably with non-cereal plant proteins. The cereal proteins may be rice proteins, oat proteins, barley proteins, wheat proteins, rye proteins, corn proteins, maize proteins and a combination thereof. The non-cereal plant proteins refer to plant-proteins different from cereal proteins. Preferably, the non-cereal proteins comprise, or consist of pulse proteins. The pulse proteins may be selected from the group consisting of bean proteins, chickpea proteins, faba bean proteins, lentil proteins, pea proteins, and a combination thereof. In a preferred embodiment, the pulse proteins are pea proteins or faba bean proteins or combination thereof. The advantages of pulse proteins, in particular pea and faba bean proteins are provided in the first aspect of the invention.

In an embodiment, the plant proteins may further comprise nut proteins, in particular coconut proteins. For example, this is the case when the shelf-stable plant-based fermented dairy analogue comprises coconut cream.

In a preferred embodiment, the shelf-stable plant-based fermented dairy analogue may have 70% to 98% of its total protein content which are non-cereal plant proteins, preferably pulse proteins.

In another preferred embodiment, the shelf-stable plant-based fermented dairy analogue has a good nutritional profile, in particular a good PDCAAS. The shelf-stable plant-based fermented dairy analogue may have a minimum PDCAAS of 0.80, preferably of 0.85-1.00, more preferably 0.90 to 1.00.

In an embodiment, the shelf-stable plant-based fermented dairy analogue may further comprise at least one non-inherent thickening agent. The non-inherent thickening agent may be a non-inherent thickening agent as provided in the first aspect of the invention. The advantages of the non-inherent thickening agent are provided in the first aspect of the invention. The amount of the non-inherent thickening agent(s) within the shelf-stable plant-based fermented dairy analogue may be the one provided in the first aspect of the invention. In an embodiment, the shelf-stable plant-based fermented dairy analogue may be substantially free, preferably entirely free from any non-inherent thickening agents, more preferably from any non-inherent thickening agents other than pectin and/or starch.

In an embodiment, the shelf-stable plant-based fermented dairy analogue may comprise 0.5 to 5 wt. %, preferably 0.6 to 4 wt. %, more preferably 1 to 4 wt. %, most preferably 1 to 3 wt % starch. The shelf-stable plant-based fermented dairy analogue may comprise 0 to 1 wt. %, preferably 0.05 to 1 wt. % starch, more preferably 0.05 to 0.5 wt. % beta-glucan. These contents may contribute to provide an appropriate texture which is suitable/adapted for consumption with a flexible container.

In another embodiment, the shelf-stable plant-based fermented dairy analogue may further comprise at least one fermentable sugar-containing component. Details and advantages of the fermentable sugar-containing component provided in the first aspect of the invention. Hence, the shelf-stable plant-based fermented dairy analogue may comprise fermentable sugar, including the fermentable sugar derived from the fermentable sugar-containing component. During fermentation, only part of fermentable sugar may be used such that fermentable sugar remains in the final shelf-stable plant-based fermented dairy analogue of the packaged food product.

In a particular embodiment, the shelf-stable plant-based fermented dairy analogue may comprise from 0 wt % to 15 wt %, preferably 1 wt % to 15 wt %, more preferably 1 wt % to 10 wt %, most preferably 2 wt % to 8 wt % of fermentable sugar or fermentable-sugar containing component. In another embodiment, the shelf-stable plant-based fermented dairy analogue may comprise a total carbohydrates content of 1 to 20 wt %, preferably, 5 to 18 wt %.

During fermentation, part or all of the fermentable sugar is converted into organic acids. Hence, the shelf-stable plant-based fermented dairy analogue may comprise organic acids. In particular, the shelf-stable plant-based fermented dairy analogue may comprise at least 0.3 g organic, preferably 0.3 g to 1.0 g organic acid, more preferably 0.3 g to 0.5 g of organic acid per 100 g of shelf-stable plant-based fermented dairy analogue. In a preferred embodiment, the organic acid is lactic acid. In another embodiment, the organic acid is a combination of lactic acid and acetic acid.

The formation of organic acids results in an acidic pH. In particular, the shelf-stable plant-based fermented dairy analogue has a pH of 3.0 to 5.0, preferably of 3.5 to 4.5.

In another embodiment, the shelf-stable plant-based fermented dairy analogue may further comprise vegetable fat component. Details and advantages of the vegetable fat component are provided in the first aspect of the invention. Hence, the shelf-stable plant-based fermented dairy analogue may comprise vegetable, including the vegetable fat derived from the fermentable sugar-containing component.

In an embodiment, the shelf-stable plant-based fermented dairy analogue may comprise 0 wt % to 10 wt %, preferably 1 wt % to 10 wt %, more preferably 1 to 5 wt % of vegetable fat component. In a further embodiment, the shelf-stable plant-based fermented dairy analogue may comprise a total fat content of 0 wt % to 15 wt %, preferably 1 wt % to 15 wt %, more preferably 1 wt % to 10 wt %, most preferably 1 to 5 wt % fat.

In a preferred embodiment, the totality of the fat of the plant-based food composition may consist of vegetable fat.

In another embodiment, the shelf-stable plant-based fermented dairy analogue may further comprise algae, antioxidants, cocoa, colours, fibres, flavours, flower essences, fruit preparations, minerals, salts, prebiotics, sauces, solid inclusions, spices, sweeteners, tea, vegetables and/or vitamins. The fruit preparation may be a fruit preparation as provided in the first aspect of the invention.

In an embodiment, the shelf-stable plant-based fermented dairy analogue may be free from any exogenous enzymes, in particular free from any exogenous hydrolysing enzymes and/or any protein crosslinking enzymes. In particular, the shelf-stable plant-based fermented dairy analogue may be free from exogenous starch-degrading and/or exogenous beta-glucan-degrading enzymes and/or fiber-degrading enzymes and/or protein-degrading enzymes and/or protein crosslinking enzymes. Examples of the different type of enzymes are provided in the first aspect of the invention. By “exogenous enzymes”, it relates to enzymes that are not inherently present in the plant-based ingredients (e.g. plant protein-containing ingredient, cereal flour) or the starter culture of the shelf-stable plant-based fermented dairy analogue.

In an embodiment, the starches and/or the plant proteins and/or the fibers and/or the beta-glucans of the shelf-stable plant-based fermented dairy analogue is/are not enzymatically hydrolysed.

In an embodiment, the plant proteins of the shelf-stable plant-based fermented dairy analogue are not cross-linked, in particular enzymatically cross-linked. By “not cross-linked”, it is understood that the glutamine and lysine amino acid residues of the plant proteins are not cross-linked, i.e. are not linked by covalent linkages, in particular by isopeptide bond or amide bond, between the γ-carboxamide group of glutamine amino acid residue and the free amine group of lysine amino acid residue.

The shelf-stable plant-based fermented dairy analogue has a shelf-life of at least 3 months, preferably at least 6 months, more preferably at least 9 months, most preferably at least 12 months under ambient conditions without involving sanitary risks. By “ambient conditions”, it is understood at a temperature of 15° C. to 40° C., preferably of 20° C. to 37° C., more preferably of 20° C. to 35° C. In a more preferred embodiment the plant-based fermented dairy analogue may have a shelf-life of 3 months to 36 months, preferably of 3 months to 24 months, more preferably of 3 months to 12 months, most preferably of 3 months to 6 months under ambient conditions. The advantages of such extended shelf-life under ambient conditions are provided in the first aspect of the invention. In an embodiment, the abovementioned shelf-life values apply at a relative humidity of 60% to 75%.

The shelf-stable plant-based fermented dairy analogue has a viscosity of 300 to 1200 mPa.s, preferably of 350 to 1100 mPa.s, more preferably of 350 to 850 mPa.s, most preferably of 350 to 500 mPa.s at 100 s⁻¹ at 20° C. when measured by means of a rheometer with plate-plate geometry (60 mm diameter) and with 1 mm gap. Example method to measure viscosity is provided in the first aspect of the invention. The advantage of this texture is provided in the first aspect of the invention.

The packaged food product of the second aspect of the invention has several advantages. In particular, the shelf-stable plant-based fermented dairy analogue of the packaged food product comprises a substantial amount of protein while having a satisfactory texture over shelf-life. In particular, it has a stable texture (e.g. no separation of phase) and smooth texture (i.e. no grains) over a storage of several months under ambient conditions. In addition, it has a texture that can mimic the texture of fermented dairy products, such as yogurts. Moreover, the shelf-stable plant-based fermented dairy analogue of the packaged food product has a texture which is suitable for consumption with a flexible container such as flexible pouch. The texture of the shelf-stable plant-based fermented dairy analogue is neither too thick nor too liquid such that the abovementioned drawbacks related to such textures are avoided. In particular, the shelf-stable plant-based fermented dairy analogue of the packaged food product of the second aspect of the invention may be discharged from the flexible container and so consumed/served easily through the opening without applying excessive efforts and without uncontrolled discharged. The shelf-stable plant-based fermented dairy analogue has flowing properties such that it is not blocked within the flexible container of the packaged food product. Wastes are therefore limited. Preferably, the shelf-stable plant-based fermented dairy analogue of the packaged food product has good taste and limited off-notes.

Those skilled in the art will understand that they can freely combine all features of the present invention disclosed herein. Further, features described for different embodiments of the present invention may be combined.

Furthermore, where known equivalents exist to specific features, such equivalents are incorporated as if specifically referred in this specification. Further advantages and features of the present invention are apparent from the figures and non-limiting examples.

### EXAMPLES

### Example 1

### Assessment of the Viscosity of the Samples

The viscosity of the different samples, in particular the shelf-stable plant-based fermented dairy analogues were measured as follows. The packaged food products after being stored for a predetermined time after filling step (e.g. 7 days after filling, 1 month after filling etc.) at room temperature were stored at a temperature of 20° C. for a minimum of 2 hours prior to the measurement. Then, the shelf-stable plant-based fermented dairy analogues were discharged from the flexible container and were gently stirred in a circular motion 3 times before transferring to Rheometer Haake RS600 (ThermoFisher Scientific, Waltham, Massachusetts, United-States) with plate/plate geometry (60 mm diameter), especially plate/plate geometry PP60, and with 1 mm gap. Flow curves with controlled shear rate ramp from 0 to 300 s⁻¹ (linear increase) were obtained at 10° C.+/−0.1. Especially, the viscosity was measured using Rheowin software (ThermoFisher Scientific, Waltham, Massachusetts, United-States) in terms of Pa*s at 100s⁻¹ at 20° C.

### Example 2

### Preparation of Shelf-Stable Plant-Based Fermented Dairy Analogue Variants Comprising Pea Proteins and Packaged in Flexible Pouches

A packaged food product comprising a shelf-stable fermented dairy analogue packaged into a flexible pouch was prepared. It has a PDCAAS of 0.9. The shelf-stable fermented dairy analogue of the packaged food product is called hereinafter pea variant 1.

The recipe of pea variant 1 is provided in table 1.

TABLE 1

| | Content in Pea variant 1 |
|---|---|
| Ingredients | (wt %) |
| Non-hydrolysed oat flour* | 1.73 |
| Pea protein isolate (80% proteins) | 4.09 |
| Coconut cream | 2.81 |
| Starch | 1.5 |
| High methoxyl Pectin | 0.52 |
| Fruit preparation | 15.7 |
| Colors | 0.60 |
| Salts | 1.00 |
| Vitamins | 0.14 |
| Sucrose | 8.33 |
| Water | 63.58 |

*The non-hydrolysed oat flour comprises 68 wt. % carbohydrates, including 65.3 wt. % starch and 8.3 wt. % fibers, including 3 wt % beta glucan.

Pea variant 1 was prepared as follows. The ingredients of table 1, except the fruit preparation, the starch and the pectin, were mixed for 10 minutes to obtain a plant-based food composition. The plant-based food composition has a total protein content of 3.74 wt. %, including a pea protein content of 3.27 wt. %. Thereafter, the plant-based food composition was heated while stirring at 60° C. for 10 minutes to obtain a gelatinized plant-based food composition. The gelatinized plant-based food composition was first homogenized at 200 bars/50 bars at 65° C. and then was heat-treated at 92° C. for 60 seconds. The homogenized and heat-treated plant-based food composition was inoculated with a starter culture, e.g. comprising a Lactobacillus delbrueckii subsp. bulgaricus strain and a Streptococcus thermophilus, and was fermented, without stirring, until reaching a pH of 4.5. The obtained plant-based fermented dairy analogue was mixed with pectin and was then smoothed. The smoothed plant-based fermented dairy analogue was cooled to 15° C. and then mixed with starch and the fruit preparation. The smoothed plant-based fermented dairy analogue was thereafter heat-treated at 109° C. for 27 seconds to obtain a shelf-stable plant-based fermented dairy analogue.

The obtained shelf-stable plant-based fermented dairy analogue was then filled at 90° C. into single-serve flexible pouches to obtain a packaged food product comprising the shelf-stable plant-based fermented dairy analogue (i.e. pea variant 1) packaged in a flexible pouch. The packaged food product was cooled and stored at room temperature.

The shelf-stable plant-based fermented dairy analogue of the packaged food product, i.e. pea variant 1, was discharged from the flexible pouches. The sensory and stability of the of pea variant 1 was assessed 7 days after filling into flexible pouches. It has a stable, homogenous and smooth (i.e. without grains) texture while having a substantial amount of proteins. It does not exhibit any destabilisation phenomenon such as protein aggregations (e.g. no grains perceived visually/in mouth), separation of phase (e.g. no serum visible), despite the different heat-treatments after the fermentation.

Pea variant 1 exhibits a satisfactory texture mimicking the texture of fermented dairy products. In particular, the texture is not too thick and not too liquid. In particular, the viscosity of the shelf-stable plant-based fermented dairy analogue was assessed according to the method provided in example 1. It was measured a viscosity of 354.2 mPa.s at 100 s⁻¹ and° C.

The flowing properties of pea variant 1, was assessed by squeezing the walls of the flexible pouch manually. In particular, it was observed that pea variant 1 has a texture which is adapted for consumption with flexible pouches, i.e. not too thick or not too liquid. In particular, the shelf-stable plant-based fermented dairy analogue can be discharged easily and consumed/served from the flexible pouch without applying excessive efforts and without uncontrolled discharge. The pea variant 1 was not blocked within the flexible pouch when squeezing the walls. Waste is limited.

The same results were observed after 1 month and 3 months storage at room temperature. This highlights that the product is stable over several months at room temperature.

### Example 3

### Preparation of Shelf-Stable Plant-Based Fermented Dairy Analogue Variants Comprising Faba Bean Proteins and Packaged in Flexible Pouches

A shelf-stable fermented dairy analogue was prepared by using faba bean protein isolate, hereinafter faba bean variant 1. It has a PDCAAS of 0.93.

The recipe of faba bean variant 1 is provided in table 2.

TABLE 2

| | Content in Faba |
|---|---|
| Ingredients | bean variant 1 (wt %) |
| Non-hydrolysed oat flour* | 6.00 |
| Faba bean protein isolate | 2.54 |
| (83.8% proteins) | |
| Sucrose | 3.84 |
| Vegetable oil | 2.50 |
| Salts | 0.52 |
| Water | 84.60 |

*The non-hydrolysed oat flour comprises 68 wt. % carbohydrates, including 65.3 wt. % starch and 8.3 wt. % fibers, including 3 wt % beta glucan.

Faba bean variant 1 was prepared as follows. The ingredients of table 1 were mixed for 20 minutes to obtain a plant-based food composition. The plant-based food composition has a total protein content of 2.80 wt. %, including a faba bean protein content of 2.13 wt. %. Thereafter, the plant-based food composition was heated while stirring at 60° C. for 10 minutes to obtain a gelatinized plant-based food composition. The gelatinized plant-based food composition was first homogenized at 200 bars/50 bars at 70° C. and then was heat-treated at 92° C. for 60 seconds. The homogenized and heat-treated plant-based food composition was inoculated with a starter culture and was fermented until reaching a pH of 4.3 to 4.5. The obtained plant-based fermented dairy analogue was cooled at 4° C., smoothed and then heat-treated at 109° C. for 30 seconds to obtain a shelf-stable plant-based fermented dairy analogue.

The sensory and stability of the obtained shelf-stable plant-based fermented dairy analogue was assessed 7 days after preparation. It has a stable, homogenous and smooth (i.e. without grains) texture while having a substantial amount of proteins. It does not exhibit any destabilisation phenomenon such as aggregations (e.g. no grains perceived visually/in mouth), separation of phase (e.g. no serum visible), despite the heat-treatment after the fermentation and despite the absence of any thickening agent.

The shelf-stable plant-based fermented dairy analogue exhibits a satisfactory texture mimicking the texture of fermented dairy products. In particular, the texture is thick but remains acceptable, i.e. not too thick and not too liquid. In particular, the viscosity of the shelf-stable plant-based fermented dairy analogue was assessed according to the method provided in example 1. It was measured a viscosity of 1057 mPa.s at 100 s⁻¹ and 20° C.

The obtain shelf-stable plant-based fermented dairy analogue may be hot filled at 90° C., just after their preparation, into a single-serve flexible pouch to obtain a packaged shelf-stable plant-based fermented dairy analogue. After hot filling, it is expected that the texture of the shelf-stable plant-based fermented dairy analogue remains satisfactory, stable, homogenous and smooth without exhibiting any destabilization phenomenon.

In particular, it is expected that the shelf-stable plant-based fermented dairy analogue has a thick texture but which is still adapted for consumption with the flexible pouch i.e. not too thick or not too liquid. In particular, it is expected that the shelf-stable plant-based fermented dairy analogue can be discharged easily and consumed/served from the flexible pouch without applying excessive efforts and without uncontrolled discharge.

1. Process for preparing a packaged food product consisting of a shelf-stable plant-based fermented dairy analogue contained in a flexible container, wherein said process comprises the steps of:
(a) providing a plant-based food composition comprising plant protein-containing ingredient, cereal flour and hydrophilic liquid, wherein the plant-based food composition comprises 2.0 to 5.5 wt % plant proteins, wherein the plant protein-containing ingredient is different from the cereal flour,
(b) heating the plant-based food composition at 55°° C. to 80° C. for 5 to 15 minutes to obtain a gelatinized plant-based food composition,
(c) homogenizing the gelatinized plant-based food composition at a pressure above 50 bar,
(d) heat treating the gelatinized plant-based food composition at a temperature from 80°° C. to 100° C. for 30 seconds to 10 minutes,
(e) inoculating the heat-treated and homogenized plant-based food composition with at least one starter culture to obtain an inoculated plant-based food composition,
(f) fermenting the inoculated plant-based food composition until reaching a pH of 3.0 to 5.0, to obtain a plant-based fermented dairy analogue,
(g) heat-treating the plant-based fermented dairy analogue at a temperature from 75° C. to 125° C. for 3 seconds to 15 minutes to obtain a shelf-stable fermented dairy analogue,
(h) hot filling the shelf-stable fermented dairy analogue into a flexible container at a temperature of 80°° C. to 100°° C. to obtain a packaged food product.

2. Process according to claim 1, wherein the plant-based food composition and/or the shelf-stable plant-based fermented dairy analogue of the packaged food product is free from dairy components and/or free from soy components.

3. Process according to claim 1, wherein the plant protein-containing ingredient is selected from the group consisting of a plant protein concentrate, a plant protein isolate and a plant protein flour.

4. Process according to claim 1, wherein the proteins of the plant protein-containing ingredient consist of pulse proteins.

5. Process according to claim 1, wherein the cereal flour is hydrolysed oat flour, non-hydrolysed oat flour or a combination thereof.

6. Process according to claim 1, wherein the plant-based food composition has 70% to 98% of its total protein content which is originated from the plant protein-containing ingredient.

7. Process according to claim 1, wherein the homogenization step (c) is upstream to the heat-treatment step (d).

8. Process according to claim 1, wherein the flexible container is a flexible pouch, preferably a single-serve flexible pouch.

9. Process according to claim 1, wherein the fermentation step (f) is performed without stirring.

10. Process according to claim 1, wherein the process comprises a step of adding at least one non-inherent thickening agent into the plant-based fermented dairy analogue between step (f) and step (g).

11. Process according to claim 10, wherein the thickening agent comprises pectin and/or starch.

12. Process according to claim 11, wherein pectin is added such that the plant-based fermented dairy analogue comprises from 0.05 wt % to 2.0 wt % of pectin.

13. Process according to claim 11, wherein the starch is added such that the plant-based fermented dairy analogue comprises from 0.1 wt % to 3.0 wt % of starch.

14. Process according to claim 11, wherein the non-inherent thickening agent comprises starch and pectin and wherein the starch and pectin are added separately.

15. Process according to claim 1, wherein the shelf-stable plant-based fermented dairy analogue of the packaged food product has a shelf-life of at least 3 months at a temperature of 15° C. to 40° C. and/or has a viscosity of 300 to 1200 mPa.s at 100 s⁻¹ at 20° C. measured by means of a rheometer with plate-plate geometry (60 mm diameter) and with 1 mm gap.

16. A packaged food product which consists of a shelf-stable plant-based fermented dairy analogue contained in a flexible container, and wherein the shelf-stable plant-based fermented dairy analogue comprises:
hydrophilic liquid,
plant proteins,
and said shelf-stable plant-based fermented dairy analogue has:
a pH of 3.0 to 5.0,
from 2.0 wt % to 5.5 wt % of plant protein,
a shelf-life of at least 3 months at a temperature of 15°° C. to 40°° C., and
a viscosity of 300 to 1200 mPa.s at 100 s⁻¹ at 20°° C. measured by means of a rheometer with plate-plate geometry (60 mm diameter) and with 1 mm gap.

17. (canceled)
